(19) United States
(12) Patent Application Publication
(10) Pub. No.: US 2026/0018679 A1
(43) Pub. Date: Jan. 15, 2026

(54) CELL AND LITHIUM-ION SECONDARY BATTERY

(71) Applicant: ZHUHAI COSMX BATTERY CO., LTD., Zhuhai (CN)

(72) Inventors: Jiao Li, Zhuhai (CN); Jialin Fang, Zhuhai (CN)

(21) Appl. No.: 19/263,451

(22) Filed: Jul. 8, 2025

(30) Foreign Application Priority Data
Jul. 10, 2024 (CN) 202410923403.7

(51) Int. Cl. H01M 10/0587; H01M 10/0525; H01M 50/434

(52) U.S. Cl. CPC H01M 10/0587; H01M 10/0525; H01M 50/434

(57) ABSTRACT

The disclosure provides a cell and a lithium-ion secondary battery. The cell includes a positive electrode plate, a separator, and a negative electrode plate. The negative electrode plate includes a negative electrode current collector and a negative electrode active material layer, wherein a surface of the negative electrode active material layer is provided with a first recess, the first recess has a depth H in μm, the cell has a length L in mm, and the cell has a width W in mm; and H, L and W satisfy: 0.05H≤L/W≤0.5H.

### CROSS-REFERENCE TO RELATED APPLICATIONS

This application claims the priority to Chines Patent Application No. 202410923403.7, filed Jul. 10, 2024, the content of which is incorporated herein by reference for all purposes.

### TECHNICAL FIELD

The present application relates to the technical field of lithium-ion secondary batteries, and in particular to a cell and a lithium-ion secondary battery.

### BACKGROUND ART

With the rapid development of lithium-ion secondary battery technologies, the electrical performance of lithium-ion secondary batteries has been further improved, and energy density and charging rate have become the focus of research and development of major lithium-ion secondary battery manufacturers. In order to increase the energy density of the lithium-ion secondary battery, the compaction density of an active material layer is generally increased, which tends to cause polarization of the lithium-ion secondary battery during charging, resulting in a decrease in the mobility of lithium ions and hence reducing the charging rate of the lithium-ion secondary battery. In addition, the content of an electrolyte is low, resulting in a short battery life.

### SUMMARY

In view of this, the present application provides a cell to solve the problems of low charging rate and short battery life of a lithium-ion secondary battery. The present application also provides a lithium-ion secondary battery including the cell described above.

In order to achieve the above objective, the present application provides the following technical solutions.

A cell includes a positive electrode plate, a separator and a negative electrode plate, the negative electrode plate including a negative electrode current collector and a negative electrode active material layer, where a surface of the negative electrode active material layer is provided with a first recess,
the first recess has a depth H in μm, the cell has a length L in mm, and the cell has a width W in mm; and H, L and W satisfy: 0.05H≤L/W≤0.5H.

Optionally, 1≤L/W≤5;
H is in a range of 2≤H≤40; and/or
L is in a range of 20≤L≤160; and/or
W is in a range of 15≤W≤80.

Optionally, a spacing S in mm is provided between the first recesses, where W and S satisfy: 0.01≤S/W≤0.06; and
preferably, S is in a range of 0.5≤S≤3.

Optionally, a spacing S in mm is provided between the first recesses, where H, L, W and S satisfy: 0.04 H≤L*S/W≤0.45 H; and
preferably, S is in a range of 0.5≤S≤3.

Optionally, the separator is located between the positive electrode plate and the negative electrode plate, the separator includes a ceramic layer close to the positive electrode plate, and the ceramic layer has a thickness M in μm, where M and H satisfy: 2.5≤H/M≤40; and
preferably, M is in a range of 0.3≤M≤5.

Optionally, the separator is located between the positive electrode plate and the negative electrode plate, the separator includes a ceramic layer close to the positive electrode plate, Dv50 of the ceramic layer is defined as N in μm, and the first recess has a width Vin μm, where N and V satisfy: 3≤V/N≤3,000;
preferably, V is in a range of 20≤V≤200; and/or N is in a range of 0.02≤N≤2.

Optionally, the negative electrode active material layer is arranged on at least one side of the negative electrode current collector, the negative electrode active material layer includes a first active layer close to the negative electrode current collector and a second active layer away from the negative electrode current collector, and Dv50 of an active material of the first active layer is greater than Dv50 of an active material of the second active layer, and the second active layer has a thickness P in μm, where P and H satisfy: 1<P/H≤5; and
preferably, P is in a range of 8≤P≤1,000.

Optionally, the positive electrode plate includes a positive electrode current collector and a positive electrode active material layer, a sum of contents of aluminum and magnesium of an active material of the positive electrode active material layer is defined as Q in ppm, and a content of silicon of an active material of the negative electrode active material layer is defined as R, where Q, R and H satisfy: 1*10³≤Q/(R*H)≤1*10⁵;
Q is in a range of 1,000≤Q≤10,000; and/or R is in a range of 1%≤R≤30%.

Optionally, the negative electrode plate is provided with an extension beyond the positive electrode plate in a length direction of the cell, the extension having a dimension D in mm in the length direction of the cell, where D and H satisfy: 0.05≤D/H≤0.25; and
preferably, D is in a range of 0.1≤D≤2.

Optionally, a second recess is formed in a region of the negative electrode active material layer opposite to a positive tab of the cell in a thickness direction of the cell, and distances between two lateral edges of the second recess and adjacent first recesses are defined as T in mm and U in mm respectively in a width direction of the cell, where T and U are both greater than 0.

Optionally, a housing and a cell arranged inside the housing as described in any one of the above items are included.

According to the cell provided by the present application, the provision of the first recess on the negative electrode plate can improve a flow guide channel of an electrolyte, accelerate the wetting of the electrode plates by the electrolyte, shorten the distance of contact between the negative electrode active material layer and the electrolyte, reduce polarization of surfaces and insides of the electrode plates, and improve the charging performance. The provision of the first recess increases the area of contact between the active materials and the electrolyte, improves the movement efficiency of lithium ions during charging of the lithium-ion secondary battery, and also improves the charging efficiency. The provision of the first recess can facilitate the discharge of a gas that is probably generated during operation of the lithium-ion secondary battery, thereby improving the gas discharge function of the lithium-ion secondary battery, preventing the lithium-ion secondary battery from swelling, and thus improving the safety of the lithium-ion secondary battery. The provision of the first recess can increase the storage capacity of the electrolyte and increase a residual electrolyte coefficient, and thus prolong the service life of the lithium-ion secondary battery. In addition, by ensuring that the depth of the first recess, the length of the cell and the width of the cell satisfy 0.05H≤L/W≤0.5H, when the length of the cell is large, significant polarization of the cell may be caused due to that a positive electrode and a negative electrode of the lithium-ion secondary battery are arranged on one side of the cell. By increasing the depth of the first recess, the polarization of the electrode plates can be reduced, thereby increasing the charging rate and improving the cycle performance and the safety performance of the lithium-ion secondary battery.

### BRIEF DESCRIPTION OF THE DRAWINGS

To describe the technical solutions in embodiments of the present application or in the prior art more clearly, the following briefly describes the accompanying drawings required for describing the embodiments or the prior art. It is clear that the accompanying drawings in the following descriptions are merely some embodiments of the present application, and those of ordinary skill in the art may still derive other drawings from the provided accompanying drawings without creative efforts.

FIG. 1 is a front view of a cell according to an embodiment of the present application;

FIG. 2 is a top view of a tab region of a positive electrode plate;

FIG. 3 is a top view of a region of a negative electrode plate corresponding to a positive tab;

FIG. 4 is an enlarged view of part F in FIG. 3;

FIG. 5 is a sectional view taken along line G-G in FIG. 3;

FIG. 6 is a partial enlarged view of FIG. 1; and

FIG. 7 is a schematic structural diagram of a separator and an electrode plate.

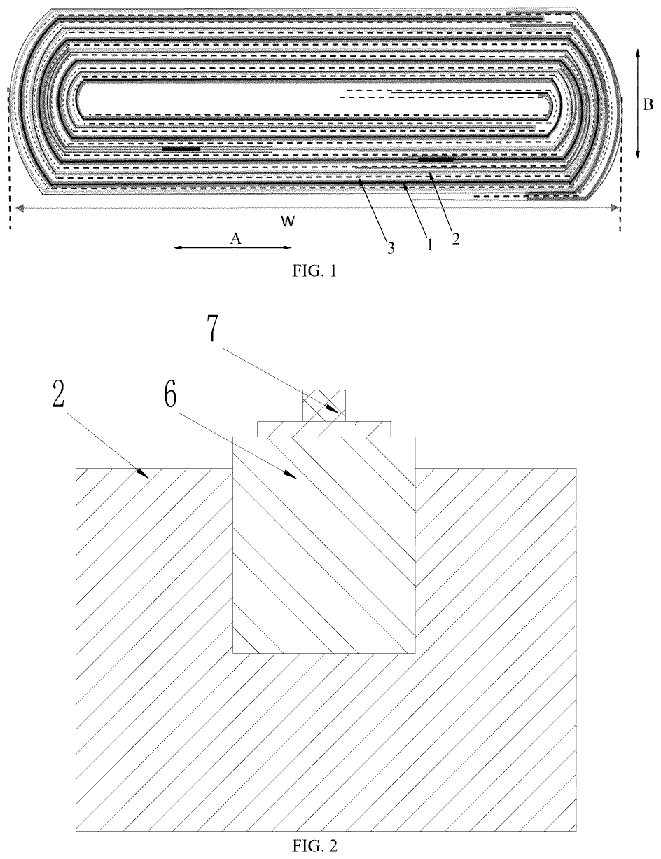

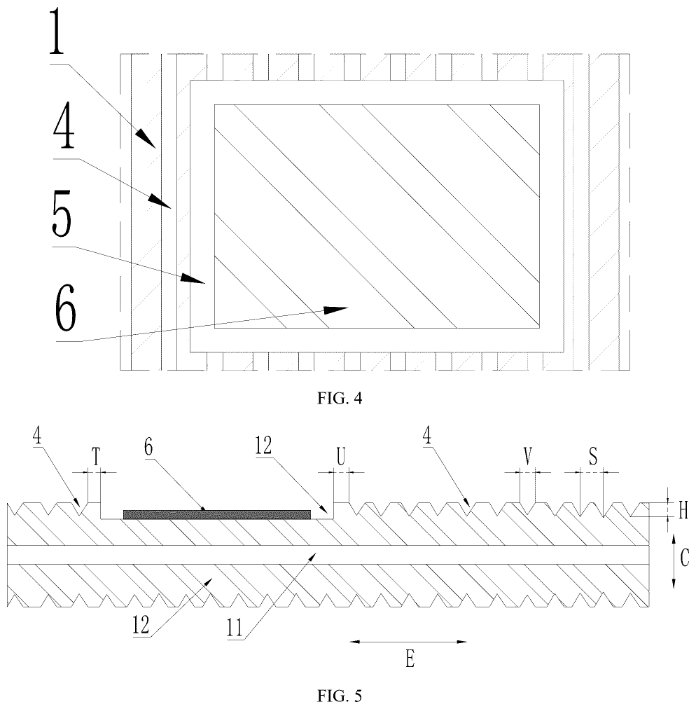

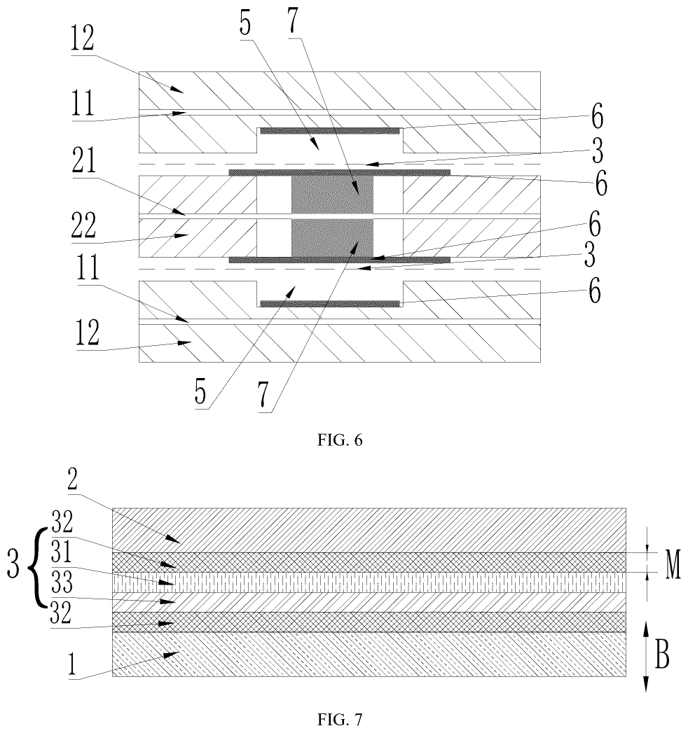

In FIGS. 1-7:

1—negative electrode plate, 2—positive electrode plate, 3—separator, 4—first recess, 5—second recess, 6—adhesive tape, 7—positive tab;

11—negative electrode current collector, 12—negative electrode active material layer, 13—extension, 21—positive electrode current collector, 22—positive electrode active material layer, 31—ceramic layer, 32—adhesive layer, 33—base layer.

### DETAILED DESCRIPTION OF EMBODIMENTS

The present application provides a cell. The present application also provides a lithium-ion secondary battery including the cell described above.

The technical solutions in the embodiments of the present application will be clearly and completely described below with reference to the drawings in the embodiments of the present application. Apparently, the embodiments described are merely some rather than all of the embodiments of the present application. All other embodiments obtained by those of ordinary skill in the art based on the embodiments of the present application without creative efforts shall fall within the scope of protection of the present application.

As shown in FIGS. 1 to 7, an embodiment of the present application provides a cell that may constitute a lithium-ion secondary battery together with an electrolyte and a structure such as a housing. The cell mainly includes a positive electrode plate 2, a separator 3, and a negative electrode plate 1. The negative electrode plate 1 includes a negative electrode current collector 11 and a negative electrode active material layer 12. A surface of the negative electrode active material layer 12 opposite to the positive electrode plate 2 is provided with a first recess 4. The provision of the first recess 4 can improve a flow guide channel of the electrolyte, accelerate the wetting of the electrode plates by the electrolyte, shorten the distance of contact between the negative electrode active material layer 12 and the electrolyte, reduce polarization of surfaces and insides of the electrode plates, and improve the charging performance. Moreover, the first recess 4 has the functions of electrolyte storage and gas discharge, so that the cycle performance and the safety of the lithium-ion secondary battery are improved. It should be noted that a depth of the first recess 4 is less than a thickness of the negative electrode active material layer 12. In this way, the negative electrode current collector 11 can be prevented from being exposed to avoid the risk of a short circuit during use of the cell, and excessive reduction of the negative electrode active material layer 12 can also be avoided to prevent excessive reduction in an energy density of the cell.

Specifically, the first recess 4 has a depth H in μm, the cell has a length L in mm, and the cell has a width W in mm, where H, L and W satisfy: 0.05H≤L/W≤0.5H. Specifically, since a tab of the cell is generally arranged at an end of the cell in a length direction, when the width of the cell remains unchanged, the greater the length of the cell, the longer the distance for electrons to flow from the end of the cell where the tab is provided to the other end where no tab is provided during charging, thereby making the cell more susceptible to polarization. Therefore, the depth of the first recess 4, the length of the cell and the width of the cell satisfy 0.05H≤L/W≤0.5H. In this way, when a ratio of the length of the cell to the width of the cell is increased, by increasing the depth of the first recess 4, the polarization of the electrode plates in the length direction of the cell can be reduced by reducing the polarization of the electrode plates in a thickness direction, so that the system has a better charging performance. Moreover, when the lithium-ion secondary battery is in a high-temperature or low-temperature environment, reducing the polarization of the lithium-ion secondary battery during charging can improve the stability of the lithium-ion secondary battery, thereby improving the stability of the lithium-ion secondary battery in the high-temperature or low-temperature environment.

In some embodiments, H is in a range of 2≤H≤40; and/or L is in a range of 20≤L≤160; and/or W is in a range of 15≤W≤80. By way of example, H may be 2, 3, 5, 10, 20, 30, 35, 38, 40, etc.; L may be 20, 22, 25, 30, 40, 50, 80, 100, 130, 150, 155, 160, etc.; and W may be 15, 16, 18, 20, 30, 50, 70, 75, 78, 80, etc. Here, by setting H, L and W to be within the ranges described above, reducing the polarization of the lithium-ion secondary battery during charging can improve the stability of the lithium-ion secondary battery, thereby improving the stability of the lithium-ion secondary battery in the high-temperature or low-temperature environment.

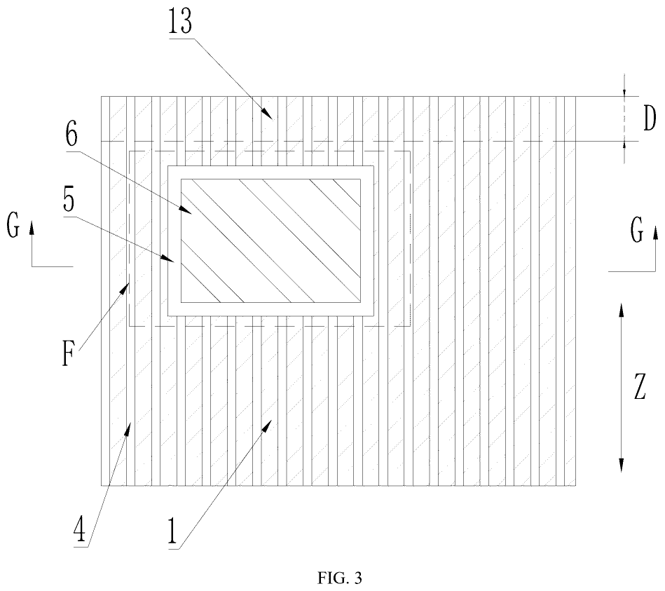

It should be noted that the width W of the cell refers to the dimension of the cell in a direction indicated by a double-headed arrow A in FIG. 1, a height direction of the cell refers to a direction indicated by an arrow B in FIG. 1, the length L of the cell refers to the dimension of the cell in a direction perpendicular to both of the double-headed arrow A and the double-headed arrow B in FIG. 1, i.e., in a direction indicated by a double-headed arrow Z in FIG. 3, and the depth H of the first recess 4 refers to the dimension of the first recess 4 in a direction indicated by a double-headed arrow C in FIG. 5.

It should also be noted that the first recess 4 may be a groove or hole formed by laser, where the groove is formed by a continuous hole.

In the electrode plates of the above structures, the provision of the first recess 4 on the negative electrode plate 1 can improve a flow guide channel of an electrolyte, accelerate the wetting of the electrode plates by the electrolyte, shorten the distance of contact between the negative electrode active material layer 12 and the electrolyte, reduce polarization of surfaces and insides of the electrode plates, and improve the charging performance. The provision of the first recess 4 increases the area of contact between the active materials and the electrolyte, improves the movement efficiency of lithium ions during charging of the lithium-ion secondary battery, and also improves the charging efficiency. The provision of the first recess 4 can facilitate the discharge of a gas that is probably generated during operation of the lithium-ion secondary battery, thereby improving the gas discharge function of the lithium-ion secondary battery, preventing the lithium-ion secondary battery from swelling, and thus improving the safety of the lithium-ion secondary battery. The provision of the first recess 4 can increase the storage capacity of the electrolyte and increase a residual electrolyte coefficient, and thus prolong the service life of the lithium-ion secondary battery. In addition, by ensuring that the depth of the first recess 4, the length of the cell and the width of the cell satisfy 0.05H≤L/W≤0.5H, when the length of the cell is large, significant polarization of the cell may be caused due to that a positive electrode and a negative electrode of the lithium-ion secondary battery are arranged on one side of the cell. By increasing the depth of the first recess 4, the polarization of the electrode plates can be reduced, thereby increasing the charging rate, relieving lithium plating in the lithium-ion secondary battery, and improving the cycle performance and the safety performance of the lithium-ion secondary battery.

In some embodiments, when 1≤L/W≤5, in particular when 1≤L/W≤3, the cell is a narrow and elongated cell, i.e., the dimension of the cell in the length direction of the cell is large. In this case, during charging, in the length direction of the cell, the distance between the end of the cell where the tab is provided and the end of the cell where no tab is provided is longer. In this way, the polarization may be greater in the length direction of the cell during charging, leading to a lower charging efficiency when the cell is being charged. It is ensured that 0.05H≤L/W≤0.5H when 1≤L/W≤3. The polarization of the lithium-ion secondary battery is further alleviated by increasing the depth of the groove. Thus, excessive polarization is avoided while the energy density of the lithium-ion secondary battery is increased, and excessive reduction in the rate of the lithium-ion secondary battery is avoided, so as to achieve a balance between the energy density and the charging rate of the lithium-ion secondary battery.

In some embodiments, L is in a range of 20≤L≤160; and/or W is in a range of 15≤W≤80. By way of example, L may be 20, 22, 25, 30, 40, 50, 80, 100, 130, 150, 155, 160, etc. W may be 15, 16, 18, 20, 30, 50, 70, 75, 78, 80, etc. Here, by setting L and W to be within the ranges described above, the polarization of the lithium-ion secondary battery is further alleviated. Thus, excessive polarization is avoided while the energy density of the lithium-ion secondary battery is increased, and excessive reduction in the rate of the lithium-ion secondary battery is avoided, so as to achieve a balance between the energy density and the charging rate of the lithium-ion secondary battery.

In some embodiments, a spacing S in mm is provided between the first recesses 4, where W and S satisfy: 0.01≤S/W≤0.06. Ensuring that a ratio of the spacing between the first recesses 4 to the width of the cell is within the range described above can further improve a flow guide channel of the electrolyte, further accelerate the wetting of the negative electrode plate 1 and the positive electrode plate 2 by the electrolyte, further shorten the distance of contact between an internal paste and an interface, further reduce polarization of surfaces and insides of the electrode plates, and improve the charging performance of the system. Moreover, a linear channel has the functions of electrolyte storage and gas discharge, and improves the cycle performance and the safety of the lithium-ion secondary battery.

By way of example, a ratio of the spacing between the first recesses 4 to the width of the cell may be 0.01, 0.02, 0.03, 0.04, 0.05, 0.06, etc.

It should be noted that the spacing S between the first recesses 4 refers to the dimension between adjacent first recesses 4 in a direction indicated by a double-headed arrow E in FIG. 5.

In some embodiments, W is in a range of 15≤W≤80; and/or S is in a range of 0.5≤S≤3. By way of example, W may be 15, 16, 18, 20, 30, 50, 70, 75, 78, 80, etc.; and S may be 0.5, 0.52, 0.55, 0.6, 0.8, 1, 1.5, 2, 2.6, 2.9, 2.95, 2.98, 3, etc. Ensuring that S and W are within the ranges described above can further shorten the distance of contact between the internal paste and the interface, further reduce polarization of surfaces and insides of the electrode plates, and improve the charging performance of the system. Moreover, the linear channel has the functions of electrolyte storage and gas discharge, and improves the cycle performance and the safety of the lithium-ion secondary battery.

In some embodiments, a spacing S in mm is provided between the first recesses 4, where H, L, W and S satisfy: 0.04H≤L*S/W≤0.45H. By way of example, the greater the ratio L/W of the length of the cell to the width of the cell, the more serious the polarization of the cell in the length direction. In this case, by increasing the depth H of the first recess 4, or by reducing the spacing S between the first recesses 4, or by increasing the depth H of the first recess 4 and reducing the spacing S between the first recesses 4, i.e., by increasing the depth of the first recess 4 and/or increasing the number of first recesses 4, the polarization can be reduced, thereby increasing the charging rate of the cell during charging.

Specifically, when the dimensions of the cell are determined, i.e., when the ratio of the length of the cell to the width of the cell is determined, if the polarization of the cell is reduced by adjusting the spacing between the first recesses 4, ensuring that 0.04H≤L*S/W≤0.45H can prevent the spacing between the first recesses 4 and the depth of the first recesses 4 from being too small, thereby avoiding a non-significant effect in reducing the polarization of the cell and also avoiding a non-significant effect in increasing the electrolyte storage capacity of the cell. If the polarization of the cell is reduced by adjusting the depth of the first recess 4, ensuring that 0.04H≤L*S/W≤0.45H can prevent the depth of the first recess 4 and the spacing between the first recesses 4 from being too large, thereby preventing the first recesses 4 from being formed too sparsely, and avoiding the phenomenon that the polarization effect is significantly reduced in a region with excessively spaced first recesses 4 while the polarization effect is not significantly reduced in the remaining region. The spacing between the first recesses 4 is prevent from being too small, so that the probability of overlap of the first recesses 4 is avoided. Moreover, the first recesses 4 are generally formed by means of laser grooving, and laser grooving may cause inactivation of part of the active material layer at a grooved position, so that preventing the first recesses 4 from being formed too densely can also increase the energy density of the cell.

In some embodiments, H is in a range of 2≤H≤40; and/or L is in a range of 20≤L≤160; and/or W is in a range of 0.5≤W≤3; and/or S is in a range of 0.5≤S≤3. By way of example, H may be 2, 3, 5, 10, 20, 30, 35, 38, 40, etc.; L may be 20, 22, 25, 30, 40, 50, 80, 100, 130, 150, 155, 160, etc.; W may be 15, 16, 18, 20, 30, 50, 70, 75, 78, 80, etc.; and S may be 0.5, 0.52, 0.55, 0.6, 0.8, 1, 1.5, 2, 2.6, 2.9, 2.95, 2.98, 3, etc. Here, by setting H, L, W and S to be within the ranges described above, the spacing between the first recesses 4 is prevent from being too small, so that the probability of overlap of the first recesses 4 is avoided. Moreover, the first recesses 4 are generally formed by means of laser grooving, and laser grooving may cause inactivation of part of the active material layer at a grooved position, so that preventing the first recesses 4 from being formed too densely can also increase the energy density of the cell.

In some embodiments, the separator 3 is located between the positive electrode plate 2 and the negative electrode plate 1, and the separator 3 includes a ceramic layer 31 close to the positive electrode plate 2. The ceramic layer 31 has a thickness M in μm, where M and H satisfy: 2.5≤H/M≤40. Since the surface of the negative electrode active material layer 12 opposite to the positive electrode plate 2 is provided with the first recess 4, the negative electrode plate 1 is in close contact with the separator 3 after the cell is subjected to formation and high-temperature hot-pressing, to ensure that the ratio of the depth of the first recess 4 to the thickness of the ceramic layer 31 of the separator 3 close to the negative electrode plate 1 is within the above range. The ceramic layer 31 may be attached to the first recess 4 by hot-pressing the ceramic layer 31 and adhesive layers 32 of the separator 3. Such an arrangement can prevent the original first recess 4 from being filled with the ceramic layer 31 and prevent the first recess 4 from failing to increase the electrolyte storage capacity. It should be noted that as shown in FIG. 7, the separator 3 includes a base layer 33, a ceramic layer 31 and adhesive layers 32. The ceramic layer 31 is arranged on a side of the base layer 33 close to the positive electrode plate 2, an adhesive layer 32 is arranged on a side of the ceramic layer 31 close to the positive electrode plate 2, and an adhesive layer 32 is arranged on a side of the base layer 33 close to the negative electrode plate 1. That is, in a direction from the negative electrode plate 1 to the positive electrode plate 2, the separator 3 includes the adhesive layer 32, the base layer 33, the ceramic layer 31 and the adhesive layer 32 distributed in sequence.

By way of example, the ratio of the depth of the first recess 4 to the thickness of the ceramic layer 31 of the separator 3 close to the negative electrode plate 1 may be 2.5, 3, 5, 8, 10, 15, 20, 30, 35, 38, 39, 40, etc.

It should be noted that the ceramic layer 31 has a thickness M, and the thickness of the ceramic layer 31 refers to the dimension of the ceramic layer 31 in a direction indicated by a double-headed arrow B in FIG. 7.

In some embodiments, H is in a range of 2≤H≤40; and/or M is in a range of 0.3≤M≤5. By way of example, H may be 2, 3, 5, 10, 20, 30, 35, 38, 40, etc.; and M may be 0.3, 0.4, 0.8, 1.5, 3, 4, 4.5, 4.8, 5, etc. Here, by setting H and M to be within the above ranges, the ceramic layer 31 may be attached to the first recess 4 by hot-pressing the ceramic layer 31 and the adhesive layers 32 of the separator 3. Such an arrangement can prevent the original first recess 4 from being filled with the ceramic layer 31 and prevent the first recess 4 from failing to increase the electrolyte storage capacity.

In some embodiments, the separator 3 is located between the positive electrode plate 2 and the negative electrode plate 1, and the separator 3 includes a ceramic layer 31 close to the positive electrode plate 2. Dv50 of the ceramic layer 31 is defined as N in μm, and the first recess 4 has a width V in μm, where N and V satisfy: 3≤V/N≤3,000. Specifically, since the ceramic layer 31 of the separator 3 is close to the first recess 4, and the ceramic layer 31 includes a plurality of ceramic particles, during charging and discharging of the cell, gaps between the ceramic particles form a channel for lithium ions to move. Here, by setting the ratio of the width of the first recess 4 to the ceramic particles to be within the range described above, the width of the first recess 4 can be increased when external diameters of the ceramic particles are increased, to prevent the excessively large ceramic particles from blocking the first recess 4 and avoid affecting movement of the lithium ions, thereby increasing the mobility of the lithium ions and the charging rate of the cell.

It should be noted that Dv50 of the ceramic layer 31 is measured by using laser particle size; and the width of the first recess 4 refers to the dimension in a direction indicated by the double-headed arrow E in FIG. 5.

In some embodiments, V is in a range of 20≤V≤200; and/or Nis in a range of 0.02≤N≤2. By way of example, V may be 20, 22, 25, 30, 50, 80, 100, 150, 180, 190, 192, 195, 198, 200, etc. Here, by setting V and N to be within the ranges described above, the width of the first recess 4 can be increased when external diameters of the ceramic particles are increased, to prevent the excessively large ceramic particles from blocking the first recess 4 and avoid affecting movement of the lithium ions, thereby increasing the mobility of the lithium ions and the charging rate of the cell.

In some embodiments, the negative electrode active material layer 12 is arranged on at least one side of the negative electrode current collector 11. In the lithium-ion secondary battery, in order to increase the energy density of the cell, the compaction density of the active material layer is generally increased, i.e., the density of the active material layer is increased, causing the movement of the lithium ions being hindered during charging and discharging of the cell. Thus, the negative electrode active material layer 12 is configured as a first active layer close to the negative electrode current collector 11 and a second active layer away from the negative electrode current collector 11, and Dv50 of an active material of the first active layer is greater than Dv50 of an active material of the second active layer. In this way, gaps of the first active layer close to the active material layer can be increased, thereby improving the movement efficiency of the lithium ions, facilitating movement of the lithium ions, and increasing the charging rate of the cell.

Specifically, the first active layer and the second active layer are made of graphite materials or silicon materials with different particle sizes. The doping amount of a silicon-carbon material is 1% to 30%). The first active layer is made of large-particle graphite, and the second active layer is made of small-particle graphite. By way of example, the large-particle graphite has a particle size of 5-30 μm, and the small-particle graphite has a particle size of 3-22 μm. The graphite-doped silicon materials of the first active layer and the second active layer may be the same silicon material, or may be different silicon materials. The particle size of the graphite material or graphite-doped silicon material of the second active layer is less than the particle size of the graphite material or graphite-doped silicon material of the first active layer. A thickness of a paste (graphite material or graphite-doped silicon material) of the second active layer accounts for 20%-60% of a total thickness of the negative electrode active material layer 12. A double-layer design idea of the negative electrode is that the second active layer made of a fast-charging small-particle material is located on a side away from the negative electrode active material layer 12, and the large-particle pressure-resistance first active layer is located on a side close to the negative electrode current collector 11, to reduce polarization in a thickness direction of the negative electrode plate 1 while ensuring a high compaction density of the electrode plate.

It should be noted that the silicon material described above includes silicon carbon, silicon oxygen, silicon, silicon alloy and other materials, and a silicon-carbon material is preferred.

In this embodiment, further, the second active layer has a thickness P in μm, where P and H satisfy: 1<P/H≤3. With such an arrangement, the provision of the first recess 4 on the second active layer can shorten a distance between the large-particle graphite of the first active layer and an interface of the separator 3, and reduce the polarization in the thickness direction of the negative electrode plate 1. In combination with the arrangement of the first active layer and the second active layer of the negative electrode active material layer 12, the depth of the first recess 4 and the thickness of graphite of the second active layer are within optimal ranges. Therefore, the two technologies can simultaneously retain their advantages to control the polarization of the electrode plates at a low level and increase the charging capacity of the system.

In some embodiments, H is in a range of 2≤H≤40; and/or P is in a range of 8≤P≤1,000. By way of example, H may be 2, 3, 5, 10, 20, 30, 35, 38, 40, etc.; and P may be 8, 10, 50, 100, 300, 500, 800, 950, 990, 996, 1,000, etc. Here, by setting P and H to be within the ranges described above, in combination with the arrangement of the first active layer and the second active layer of the negative electrode active material layer 12, the depth of the first recess 4 and the thickness of graphite of the second active layer are within optimal ranges. Therefore, the two technologies can simultaneously retain their advantages to control the polarization of the electrode plates at a low level and increase the charging capacity of the system.

In some embodiments, the first recess 4 reduces polarization of the surface and the inside of the negative electrode plate 1, so that an electrode potential of the negative electrode plate 1 increases, and an electrode potential of the positive electrode plate 2 increases accordingly in case of a constant voltage, i.e., the positive electrode plate 2 is required to be made of a material with higher voltage stability under the constant-voltage system. Moreover, doping the active material of the negative electrode active material layer 12 with silicon will cause severe side reactions of gas and heat generation, and the generation of gas and heat will aggravate damage to the entire system. A structural change in lithium cobalt oxide of a positive electrode active material of the positive electrode active material layer 22 causes an irreversible damage, which may affect the performance of the lithium-ion secondary battery. Therefore, the active material of the positive electrode active material layer 22 is doped with aluminum and magnesium.

Further, the positive electrode plate 2 includes a positive electrode current collector 21 and a positive electrode active material layer 22. The positive electrode active material layer 22 includes a positive electrode material doped with Al and Mg. A sum of contents of aluminum and magnesium is defined as Q in ppm, and a content of silicon of an active material of the negative electrode active material layer 12 is defined as R, where Q, R and H satisfy: 1*10³≤Q/(R*H)≤1*10⁵. By ensuring that the sum of the contents of aluminum and magnesium of the active material of the positive electrode active material layer 22, the content of silicon of the active material of the negative electrode active material layer 12 and the depth of the first recess 4 satisfy the relation described above, when the content of silicon of the negative electrode active material layer 12 or the depth of the first recess 4 increases, problems such as polarization of the cell can be suppressed by increasing the sum of the contents of aluminum and magnesium, thereby improving the stability of the cell and prolonging the service life of the cell. It should be noted that the contents of aluminum and magnesium are achieved by doping the positive electrode material with aluminum and magnesium.

Preferably, the positive electrode material is lithium cobalt oxide.

In some embodiments, His in a range of 2≤H≤40; and/or Q is in a range of 1,000≤Q≤10,000; and/or R is in a range of 1%≤R≤30%. By way of example, H may be 2, 3, 5, 10, 20, 30, 35, 38, 40, etc.; and Q may be 1,000, 1,005, 1,050, 2,000, 3,000, 5,000, 8,000, 9,000, 9,500, 9,990, 10,000, etc. By setting H and Q to be within the ranges described above, when the silicon doping amount of the negative electrode active material layer 12 or the depth of the first recess 4 increases, problems such as polarization of the cell can be suppressed by increasing the sum of the aluminum doping amount and the magnesium doping amount, thereby improving the stability of the cell and prolonging the service life of the cell.

In some embodiments, the negative electrode plate 1 is provided with an extension 13 beyond the positive electrode plate 2 in a length direction of the cell, the extension 13 having a dimension D in mm in the length direction of the cell, where D and H satisfy: 0.05≤D/H≤0.25. Ensuring that the dimension of the extension 13 and the depth of the first recess 4 satisfy the relation described above can reduce the polarization, so that the lithium ions diffused to the extension 13 can return to the positive electrode more quickly during discharging, thereby alleviating accumulation of the lithium ions at the extension 13 and the phenomenon of edge lithium plating.

It should be noted that the length direction of the cell refers to a direction indicated by a double-headed arrow Z in FIG. 3.

In some embodiments, H is in a range of 2≤H≤40; and/or D is in a range of 0.1≤D≤2. By way of example, H may be 2, 3, 5, 10, 20, 30, 35, 38, 40, etc.; and D may be 0.1, 0.2, 0.5, 1, 1.5, 1.8, 1.95, 1.98, 2, etc. Here, by setting D and H to be within the ranges described above, polarization can be reduced, so that the lithium ions diffused to the extension 13 can return to the positive electrode more quickly during discharging, thereby alleviating accumulation of the lithium ions at the extension 13 and the phenomenon of edge lithium plating.

By way of example, a ratio of the dimension of the extension to the depth of the first recess 4 may be 0.05, 0.055, 0.06, 0.08, 0.1, 0.15, 0.2, 0.24, 0.25, etc.

In a centered tab structure, a second recess 5 may be formed on the positive electrode plate 2. In order to avoid a short circuit of contact between a positive tab and the negative electrode plate 1, an adhesive tape 6 may be provided between the positive tab and the negative electrode plate 1. The provision of the adhesive tape 6 may increase the thickness of the lithium-ion secondary battery, resulting in a reduction in the energy density of the lithium-ion secondary battery. Therefore, in some embodiments, a second recess 5 is formed in a region of the negative electrode active material layer 12 opposite to a positive tab 7 of the cell in the thickness direction of the cell, an adhesive tape 6 is provided inside the second recess 5, the adhesive tape 6 is located within a projection of the second recess 5, and the thickness of the adhesive tape 6≤a depth of the second recess 5<the thickness of the negative electrode active material layer 12 on one side, so that the overlap thickness between the tab and the adhesive tape 6 is reduced, and the idle thickness of the cell can be reduced, thereby increasing the energy density of the cell. In addition, the provision of the recesses can increase the electrolyte storage capacity of the lithium-ion secondary battery.

Distances between two lateral edges of the second recess 5 and adjacent first recesses 4 are defined as T mm and U mm respectively in the width direction of the cell, where T and U are both greater than 0. With such an arrangement, the second recess 5 and the first recess 4 are misaligned. By providing the second recess 5, the electrolyte can wet the active material layer more quickly, and the electrolyte can be better accumulated inside the second recess 5, so that more electrolyte can be accumulated in a position where the second recess 5 is located, further improving the electrolyte retention effect of the cell.

It should be noted that the depths of the first recess 4 nor the second recess 5 are not defined herein. By way of example, the depth of the second recess 5 may be greater than the depth of the first recess 4; the depth of the second recess 5 may be less than the depth of the first recess 4; or the depth of the second recess 5 may be equal to the depth of the first recess 4.

It should also be noted that the distances T and U between the two lateral edges of the second recess 5 and the adjacent first recesses 4 refer to the dimensions of the edges of the second recess 5 in a direction indicated by the double-headed arrow E in FIG. 5.

By way of example, the distances T and U between the two lateral edges of the second recess 5 and the adjacent first recesses 4 may be 0.1, 0.2, 0.5, 0.6, 0.8, 1, 2, 3, 5, 8, 10, 20, etc.

A lithium-ion secondary battery includes a housing and the cell as described above that is arranged inside the housing. Since the lithium-ion secondary battery includes the cell, the beneficial effects of the lithium-ion secondary battery brought by the cell can be found from the above and will not be repeated herein.

Hereinafter, implementations of the present application will be described in more detail with reference to examples and comparative examples. Various tests and evaluations were carried out according to the methods described below.

### Test Method

Lithium plating window: In a 25° C. constant-temperature room, the lithium-ion secondary battery was charged at a rated voltage, then caused to stand for 5 min, and discharged to 3.0 V at 1 C. The lithium-ion secondary battery was disassembled after 30 cycles. It was determined that the charging capacity of the cell was within this system window when there was no lithium plating at any position of an electrode plate. The charging system was adjusted (to a large rate or high voltage) until lithium plating of the electrode plate occurred under a certain system. At this time, a maximum charging capacity of the cell was obtained, and the system was a lithium plating window.

Particle size: Dv50 of particles was tested by using a laser particle size analyzer.

Dimension of linear groove: A test was made by using a 3D microscope.

### Example 1

In a first step, a positive electrode plate 2 is prepared. A lithium cobalt oxide material doped with 7,500 ppm of Al and Mg was prepared into a positive electrode active material slurry, a surface of a positive electrode current collector 21 was coated with the positive electrode active material slurry, baking, rolling and slitting were performed to obtain the positive electrode plate 2 having a width of 77 mm, a fixed-size slot was formed at a certain position of the positive electrode plate 2, and a tab was welded in the slot by means of laser or ultrasound.

In a second step, graphite doped with 10% of a silicon-carbon material and having a Dv50 of 15 and graphite doped with 10% of a silicon-carbon material and having a Dv50 of 10 were respectively prepared into negative active layer slurries, the negative active layer slurries were applied to a carbon-coated copper foil (a negative electrode current collector 11). The large-particle graphite doped with 10% of the silicon-carbon material was applied to the carbon-coated copper foil, the small-particle graphite doped with 10% of the silicon carbon material was applied to the surface of large-particle graphite doped with 10% of the silicon-carbon material, baking, rolling and slitting were performed to obtain a double-layer coated negative electrode plate 1 having a width of 78.5 mm, a total thickness of 100 μm and a thickness of a second active layer of 30 μm, a fixed-size slot was formed at a certain position of the negative electrode plate 1, and a copper-nickel plated tab was welded in the slot by means of laser or ultrasound. In addition, a second recess 5 was fabricated at a position of the negative electrode plate 1 where a welding region of the positive tab 7 was projected. The second recess 5 has a depth of 25 μm. The uniform linear first recesses 4 were fabricated on the surface of the negative electrode plate 1 using laser with a certain intensity. The first recess 4 had a depth of 15 μm, a width of 80 μm, and a spacing of 1.2 mm. A minimum distance between an edge of the second recess 5 and the first recess 4 was 0.6 mm.

In a third step, The positive and negative electrode plates 1 ware slit, fabricated and then wound with a separator 3 to obtain a wound core having a width of 32 mm and a length of 80 mm. The separator 3 used include a 5 μm base film, a 2 μm ceramic layer 31 and a 2 μm adhesive layer 32. The particle size Dv50 of ceramic is 100 nm.

In a fourth step, after encapsulation, baking, electrolyte filling, formation, secondary packaging, sorting and OCV, a lithium-ion secondary battery was obtained.

The electrolyte was a commercially available conventional electrolyte, in which lithium salt was LiFP6. The lithium-ion secondary batteries in the examples and comparative examples have a rated voltage of 4.5 V.

It should be noted that during charging of the lithium-ion secondary battery, the lithium plating window of the battery shown in Example 1 was 3.5 C-4.3 V to 2 C-4.5 V, indicating that the battery was charged to 4.3 V at a rate of 3.5 C, and it is necessary to reduce the rate to 2 C to further charge the battery. The size of the lithium plating window can reflect the charging rate of the lithium-ion secondary battery to some extent.

### Examples 2-4

Except for the depth of the first recess 4 in Example 1, the rest are the same as those in Example 1. Please refer to Table 1 for the values of the depths of the first recesses 4 in Examples 2-4.

### Comparative Examples 1-2

Except for the depth of the first recess 4 in Example 1. the rest are the same as those in Example 1. Please refer to Table 1 for the values of the depths of the first recesses 4 in Comparative Examples 1-2.

TABLE 1

| | | Content | | Thickness | Spacing | | |
|---|---|---|---|---|---|---|---|
| | | of Al + | | P in μm | S in mm | | |
| | | content | Silicon | of second | between | Length | Width |
| | Extension 13 | of Mg Q | doping | active | first | L in mm | W in mm |
| | D in mm | in Ppm | amount R | layer | recesses 4 | of cell | of cell |
| Example 1 | 1.5 | 7,500 | 10% | 30 | 1.2 | 80 | 32 |
| Example 2 | 1.5 | 7,500 | 10% | 30 | 1.2 | 80 | 32 |
| Example 3 | 1.5 | 7,500 | 10% | 30 | 1.2 | 80 | 32 |
| Example 4 | 1.5 | 7,500 | 10% | 30 | 1.2 | 80 | 32 |
| Example 5 | 1.5 | 7,500 | 10% | 30 | 1.2 | 40 | 40 |
| Example 6 | 1.5 | 7,500 | 10% | 30 | 1.2 | 100 | 50 |
| Comparative | 1.5 | 7,500 | 10% | 30 | 1.2 | 80 | 32 |
| Example 1 | | | | | | | |
| Comparative | 1.5 | 7,500 | 10% | 30 | 1.2 | 80 | 32 |
| Example 2 | | | | | | | |
| Comparative | 1.5 | 7,500 | 10% | 30 | 1.2 | 120 | 12 |
| Example 3 | | | | | | | |

| | | | | External | | | |
|---|---|---|---|---|---|---|---|
| | Width | | Thickness | diameter | | Residual | |
| | V in μm | | M in μm | N in μm | | electrolyte | Lithium |
| | of first | Depth | of separator | of ceramic | | coefficient | plating |
| | recess 4 | H in μm | 3 of ceramic | particles | L/W | in g/mAh | window |
| Example 1 | 80 | 15 | 2 | 0.1 | 2.5 | 1.6 | 3.5 C-4.3 V |
| | | | | | | | to 2 C-4.5 V |
| Example 2 | 80 | 10 | 2 | 0.1 | 2.5 | 1.58 | 3.5 C-4.25 V |
| | | | | | | | to 2 C-4.5 V |
| Example 3 | 80 | 30 | 2 | 0.1 | 2.5 | 1.63 | 3.5 C-4.35 V |
| | | | | | | | to 2 C-4.5 V |
| Example 4 | 80 | 45 | 2 | 0.1 | 2.5 | 1.66 | 3.5 C-4.4 V |
| | | | | | | | to 2 C-4.5 V |
| Example 5 | 80 | 15 | 2 | 0.1 | 1 | 1.62 | 3.5 C-4.23 V |
| | | | | | | | to 2 C-4.5 V |
| Example 6 | 80 | 15 | 2 | 0.1 | 2 | 1.57 | 3.5 C-4.35 V |
| | | | | | | | to 2 C-4.5 V |
| Comparative | 80 | 4 | 2 | 0.1 | 2.5 | 1.56 | 3.5 C-4.2 V |
| Example 1 | | | | | | | to 2 C-4.5 V |
| Comparative | 80 | 52 | 2 | 0.1 | 2.5 | 1.55 | 3.5 C-4.15 V |
| Example 2 | | | | | | | to 2 C-4.5 V |
| Comparative | 80 | 15 | 2 | 0.1 | 10 | 1.52 | 3.5 C-4.2 V |
| Example 3 | | | | | | | to 2 C-4.5 V |

Referring to Table 1, it can be seen from Examples 1 to 6 and Comparative Examples 1to 3 that when the depth of the first recess 4, the length of the cell and the width of the cell satisfy 0.05H≤L/W≤0.5H, it can be concluded that the residual electrolyte coefficient and the lithium plating window in Examples 1 to 6 are greater than those in Comparative Examples 1 to 3. Since the lithium-ion secondary battery may fail when the electrolyte is exhausted, the residual electrolyte coefficient of the cell represents the content of the electrolyte in the battery, and the residual electrolyte coefficient may represent the cycle life to a certain extent. The greater the residual electrolyte coefficient of the cell, the longer the battery life. During charging of the lithium-ion secondary battery, due to the wide lithium plating window of the battery shown in Example 4, the lithium-ion secondary battery may be charged directly to 4.4V at a rate of 3.5 C, while due to the narrow lithium plating window shown in Comparative Example 3, the lithium-ion secondary battery may be charged only to 4.25V at a rate of 3.5 C, and a reduction in rate is required for further charging, which, compared with Example 4, takes a long charging time. Therefore, the larger the lithium plating window, the wider the charging window, and the higher the charging speed.

### Examples 7-11

Except for the ratio of the spacing between the first recesses 4 and the width of the cell in Example 1, the rest are the same as those in Example 1. Please refer to Table 2 for the values of the spacing between the first recesses 4 and the width of the cell and the ratios thereof in Examples 7-11.

TABLE 2

| | | Content | | Thickness | Spacing | | |
|---|---|---|---|---|---|---|---|
| | | of Al + | | P in μm | S in mm | | |
| | | content | Silicon | of second | between | Length | Width |
| | Extension 13 | of Mg Q | doping | active | first | L in mm | W in mm |
| | D in mm | in Ppm | amount R | layer | recesses 4 | of cell | of cell |
| Example 1 | 1.5 | 7,500 | 10% | 30 | 1.2 | 80 | 32 |
| Example 7 | 1.5 | 7,500 | 10% | 30 | 0.78 | 80 | 50 |
| Example 8 | 1.5 | 7,500 | 10% | 30 | 1.252 | 80 | 40 |
| Example 9 | 1.5 | 7,500 | 10% | 30 | 2.5 | 80 | 44.4 |
| Example 10 | 1.5 | 7,500 | 10% | 30 | 4 | 80 | 60 |
| Example 11 | 1.5 | 7,500 | 10% | 30 | 2.5 | 80 | 30 |

| | | | | External | | | |
|---|---|---|---|---|---|---|---|
| | Width | | Thickness | diameter | | Residual | |
| | V in μm | | M in μm | N in μm | | electrolyte | Lithium |
| | of first | Depth | of separator | of ceramic | | coefficient | plating |
| | recess 4 | H in μm | 3 of ceramic | particles | S/W | in g/mAh | window |
| Example 1 | 80 | 15 | 2 | 0.1 | 0.0375 | 1.6 | 3.5 C-4.3 V |
| | | | | | | | to 2 C-4.5 V |
| Example 7 | 80 | 15 | 2 | 0.1 | 0.0156 | 1.65 | 3.5 C-4.33 V |
| | | | | | | | to 2 C-4.5 V |
| Example 8 | 80 | 15 | 2 | 0.1 | 0.0313 | 1.62 | 3.5 C-4.31 V |
| | | | | | | | to 2 C-4.5 V |
| Example 9 | 80 | 15 | 2 | 0.1 | 0.0563 | 1.57 | 3.5 C-4.35 V |
| | | | | | | | to 2 C-4.5 V |
| Example 10 | 80 | 15 | 2 | 0.1 | 0.0667 | 1.54 | 3.5 C-4.23 V |
| | | | | | | | to 2 C-4.5 V |
| Example 11 | 80 | 15 | 2 | 0.1 | 0.0833 | 1.55 | 3.5 C-4.24 V |
| | | | | | | | to 2 C-4.5 V |

Referring to Table 2, it can be seen from Examples 1 and 7 to 11 that when the width of the cell and the spacing between the first recesses 4 satisfy 0.01≤S/W≤0.06, i.e., when the residual electrolyte coefficient and the lithium plating window in Examples 1 and 7 to 9 are greater than those in Examples 10 to 11, the greater the residual electrolyte coefficient of the cell, the longer the battery life, and the greater the lithium plating window, the wider the charging window, and the higher the charging speed.

### Examples 12-16

Except for the ratio of the product of the spacing between the first recesses 4 and the length of the cell to the product of the width of the cell and the depth in Example 1, the rest are the same as those in Example 1. Please refer to Table 3 for the values of the product of the spacing between the first recesses 4 and the length of the cell and the product of the width of the cell and the depth and the ratios thereof in Examples 12-16.

TABLE 3

| | | Content | | Thickness | Spacing | | |
|---|---|---|---|---|---|---|---|
| | | of Al + | | P in μm | S in mm | | |
| | | content | Silicon | of second | between | Length | Width |
| | Extension 13 | of Mg Q | doping | active | first | L in mm | W in mm |
| | D in mm | in Ppm | amount R | layer | recesses 4 | of cell | of cell |
| Example 1 | 1.5 | 7,500 | 10% | 30 | 1.2 | 80 | 32 |
| Example 12 | 1.5 | 7,500 | 10% | 30 | 0.6 | 100 | 50 |
| Example 13 | 1.5 | 7,500 | 10% | 30 | 1.8 | 60 | 30 |
| Example 14 | 1.5 | 7,500 | 10% | 30 | 2.3 | 80 | 32 |
| Example 15 | 1.5 | 7,500 | 10% | 30 | 2 | 100 | 25 |
| Example 16 | 1.5 | 7,500 | 10% | 30 | 3 | 80 | 32 |

| | | | | External | | | |
|---|---|---|---|---|---|---|---|
| | Width | | Thickness | diameter | | Residual | |
| | V in μm | | M in μm | N in μm | | electrolyte | Lithium |
| | of first | Depth | of separator | of ceramic | | coefficient | plating |
| | recess 4 | H in μm | 3 of ceramic | particles | L*S/W | in g/mAh | window |
| Example 1 | 80 | 15 | 2 | 0.1 | 3 | 1.6 | 3.5 C-4.3 V |
| | | | | | | | to 2 C-4.5 V |
| Example 12 | 80 | 20 | 2 | 0.1 | 1.2 | 1.64 | 3.5 C-4.32 V |
| | | | | | | | to 2 C-4.5 V |
| Example 13 | 80 | 15 | 2 | 0.1 | 3.6 | 1.57 | 3.5 C-4.27 V |
| | | | | | | | to 2 C-4.5 V |
| Example 14 | 80 | 15 | 2 | 0.1 | 5.75 | 1.56 | 3.5 C-4.25 V |
| | | | | | | | to 2 C-4.5 V |
| Example 15 | 80 | 10 | 2 | 0.1 | 8 | 1.54 | 3.5 C-4.37 V |
| | | | | | | | to 2 C-4.5 V |
| Example 16 | 80 | 15 | 2 | 0.1 | 7.5 | 1.52 | 3.5 C-4.2 V |
| | | | | | | | to 2 C-4.5 V |

Referring to Table 3, it can be seen from Examples 1 and 12 to 16 that when the length of the cell, the width of the cell, the depth and the spacing between the first recesses 4 satisfy 0.04H≤L*S/W≤0.45H, i.e., when the residual electrolyte coefficient and the lithium plating window in Examples 1 and 12 to 14 are greater than those in Examples 15 to 16, the greater the residual electrolyte coefficient of the cell, the longer the battery life, and the greater the lithium plating window, the wider the charging window, and the higher the charging speed.

### Examples 17-21

Except for the ratio of the depth to the thickness of the ceramic layer 31 in Example 1, the rest are the same as those in Example 1. Please refer to Table 4 for the values of the depth and the thickness of the ceramic layer 31 and the ratios thereof in Examples 17-21.

TABLE 4

| | | Content | | Thickness | Spacing | | |
|---|---|---|---|---|---|---|---|
| | | of Al + | | P in μm | S in mm | | |
| | | content | Silicon | of second | between | Length | Width |
| | Extension 13 | of Mg Q | doping | active | first | L in mm | W in mm |
| | D in mm | in Ppm | amount R | layer | recesses 4 | of cell | of cell |
| Example 1 | 1.5 | 7,500 | 10% | 30 | 1.2 | 80 | 32 |
| Example 17 | 1.5 | 7,500 | 10% | 30 | 1.2 | 80 | 32 |
| Example 18 | 1.5 | 7,500 | 10% | 30 | 1.2 | 80 | 32 |
| Example 19 | 1.5 | 7,500 | 10% | 30 | 1.2 | 80 | 32 |
| Example 20 | 1.5 | 7,500 | 10% | 30 | 1.2 | 80 | 32 |
| Example 21 | 1.5 | 7,500 | 10% | 30 | 1.2 | 80 | 32 |

| | | | | External | | | |
|---|---|---|---|---|---|---|---|
| | Width | | Thickness | diameter | | Residual | |
| | V in μm | | M in μm | N in μm | | electrolyte | Lithium |
| | of first | Depth | of separator | of ceramic | | coefficient | plating |
| | recess 4 | H in μm | 3 of ceramic | particles | H/M | in g/mAh | window |
| Example 1 | 80 | 15 | 2 | 0.1 | 7.5 | 1.6 | 3.5 C-4.3 V |
| | | | | | | | to 2 C-4.5 V |
| Example 17 | 80 | 40 | 1 | 0.1 | 40 | 1.59 | 3.5 C-4.32 V |
| | | | | | | | to 2 C-4.5 V |
| Example 18 | 80 | 7.5 | 3 | 0.1 | 2.5 | 1.61 | 3.5 C-4.27 V |
| | | | | | | | to 2 C-4.5 V |
| Example 19 | 15 | 22 | 2.2 | 0.1 | 10 | 1.63 | 3.5 C-4.25 V |
| | | | | | | | to 2 C-4.5 V |
| Example 20 | 80 | 15 | 0.3 | 0.1 | 50 | 1.57 | 3.5 C-4.23 V |
| | | | | | | | to 2 C-4.5 V |
| Example 21 | 80 | 4 | 5 | 0.1 | 0.8 | 1.56 | 3.5 C-4.2 V |
| | | | | | | | to 2 C-4.5 V |

Referring to Table 4, it can be seen from Examples 1 and 17 to 21 that when the depth of the first recess 4 and the thickness of the ceramic layer 31 of the separator 3 satisfy 2.5≤H/M≤40, i.e., when the residual electrolyte coefficient and the lithium plating window in Examples 1 and 17 to 19 are greater than those in Examples 20 to 21, the greater the residual electrolyte coefficient of the cell, the longer the battery life, and the greater the lithium plating window, the wider the charging window, and the higher the charging speed.

### Examples 22-26

Except for the ratio of the width of the first recess 4 to Dv50 of the ceramic particles in Example 1, the rest are the same as those in Example 1. Please refer to Table 5 for the values of the width of the first recess 4 and Dv50 of the ceramic particles and the ratios thereof in Examples 22-26.

TABLE 5

| | | Content | | Thickness | Spacing | | |
|---|---|---|---|---|---|---|---|
| | | of Al + | | P in μm | S in mm | | |
| | | content | Silicon | of second | between | Length | Width |
| | Extension 13 | of Mg Q | doping | active | first | L in mm | W in mm |
| | D in mm | in Ppm | amount R | layer | recesses 4 | of cell | of cell |
| Example 1 | 1.5 | 7,500 | 10% | 30 | 1.2 | 80 | 32 |
| Example 22 | 1.5 | 7,500 | 10% | 30 | 1.2 | 80 | 32 |
| Example 23 | 1.5 | 7,500 | 10% | 30 | 1.2 | 80 | 32 |
| Example 24 | 1.5 | 7,500 | 10% | 30 | 1.2 | 80 | 32 |
| Example 25 | 1.5 | 7,500 | 10% | 30 | 1.2 | 80 | 32 |
| Example 26 | 1.5 | 7,500 | 10% | 30 | 1.2 | 80 | 32 |

| | | | | External | | | |
|---|---|---|---|---|---|---|---|
| | Width | | Thickness | diameter | | Residual | |
| | V in μm | | M in μm | N in μm | | electrolyte | Lithium |
| | of first | Depth | of separator | of ceramic | | coefficient | plating |
| | recess 4 | H in μm | 3 of ceramic | particles | V/N | in g/mAh | window |
| Example 1 | 80 | 15 | 2 | 0.1 | 800 | 1.6 | 3.5 C-4.3 V |
| | | | | | | | to 2 C-4.5 V |
| Example 22 | 30 | 15 | 2 | 0.1 | 300 | 1.56 | 3.5 C-4.3 V |
| | | | | | | | to 2 C-4.5 V |
| Example 23 | 60 | 15 | 2 | 0.02 | 3000 | 1.65 | 3.5 C-4.3 V |
| | | | | | | | to 2 C-4.5 V |
| Example 24 | 20 | 15 | 2 | 2 | 10 | 1.59 | 3.5 C-4.27 V |
| | | | | | | | to 2 C-4.5 V |
| Example 25 | 200 | 15 | 2 | 0.057 | 3500 | 1.52 | 3.5 C-4.3 V |
| | | | | | | | to 2 C-4.5 V |
| Example 26 | 80 | 15 | 2 | 0.02 | 4000 | 1.51 | 3.5 C-4.25 V |
| | | | | | | | to 2 C-4.5 V |

Referring to Table 5, it can be seen from Examples 1 and 22 to 26 that when the width of the first recess 4 and the external diameters of the ceramic particles satisfy 3≤V/N≤3000, i.e., when the residual electrolyte coefficient and the lithium plating window in Examples 1 and 22 to 24 are greater than those in Examples 25 to 26, the greater the residual electrolyte coefficient of the cell, the longer the battery life, and the greater the lithium plating window, the wider the charging window, and the higher the charging speed.

### Examples 27-31

Except for the ratio of the thickness of the second active layer to the depth in Example 1, the rest are the same as those in Example 1. Please refer to Table 6 for the values of the thickness of the second active layer and the depth and the ratios thereof in Examples 27-31.

TABLE 6

| | | Content | | Thickness | Spacing | | |
|---|---|---|---|---|---|---|---|
| | | of Al + | | P in μm | S in mm | | |
| | | content | Silicon | of second | between | Length | Width |
| | Extension 13 | of Mg Q | doping | active | first | L in mm | W in mm |
| | D in mm | in Ppm | amount R | layer | recesses 4 | of cell | of cell |
| Example 1 | 1.5 | 7,500 | 10% | 30 | 1.2 | 80 | 32 |
| Example 27 | 1.5 | 7,500 | 10% | 11 | 1.2 | 80 | 32 |
| Example 28 | 1.5 | 7,500 | 10% | 36 | 1.2 | 80 | 32 |
| Example 29 | 1.5 | 7,500 | 10% | 42 | 1.2 | 80 | 32 |
| Example 30 | 1.5 | 7,500 | 10% | 10 | 1.2 | 80 | 32 |
| Example 31 | 1.5 | 7,500 | 10% | 50 | 1.2 | 80 | 32 |

| | | | | External | | | |
|---|---|---|---|---|---|---|---|
| | Width | | Thickness | diameter | | Residual | |
| | V in μm | | M in μm | N in μm | | electrolyte | Lithium |
| | of first | Depth | of separator | of ceramic | | coefficient | plating |
| | recess 4 | H in μm | 3 of ceramic | particles | P/H | in g/mAh | window |
| Example 1 | 80 | 15 | 2 | 0.1 | 2 | 1.6 | 3.5 C-4.3 V |
| | | | | | | | to 2 C-4.5 V |
| Example 27 | 80 | 10 | 2 | 0.1 | 1.1 | 1.58 | 3.5 C-4.25 V |
| | | | | | | | to 2 C-4.5 V |
| Example 28 | 80 | 12 | 2 | 0.1 | 3 | 1.61 | 3.5 C-4.27 V |
| | | | | | | | to 2 C-4.5 V |
| Example 29 | 80 | 10 | 2 | 1 | 4.2 | 1.63 | 3.5 C-4.35 V |
| | | | | | | | to 2 C-4.5 V |
| Example 30 | 80 | 15 | 2 | 0.1 | 0.67 | 1.55 | 3.5 C-4.22 V |
| | | | | | | | to 2 C-4.5 V |
| Example 31 | 80 | 8 | 2 | 1.8 | 6.25 | 1.56 | 3.5 C-4.24 V |
| | | | | | | | to 2 C-4.5 V |

Referring to Table 6, it can be seen from Examples 1 and 27 to 31 that when the depth of the first recess 4 and the thickness of the second active layer satisfy 1<P/H≤5, i.e., when the residual electrolyte coefficient and the lithium plating window in Examples 1 and 27 to 29 are greater than those in Examples 30 to 31, the greater the residual electrolyte coefficient of the cell, the longer the battery life, and the greater the lithium plating window, the wider the charging window, and the higher the charging speed.

### Examples 32-36

Except for the ratio of the sum of the contents of aluminum and magnesium to the product of the content of silicon and the depth in Example 1, the rest are the same as those in Example 1. Please refer to Table 7 for the values of the sum of the contents of aluminum and magnesium and the product of the content of silicon and the depth and the ratios thereof in

Examples 32 to 36.

TABLE 7

| | | Content | | Thickness | Spacing | | |
|---|---|---|---|---|---|---|---|
| | | of Al + | | P in μm | S in mm | | |
| | | content | Silicon | of second | between | Length | Width |
| | Extension 13 | of Mg Q | doping | active | first | L in mm | W in mm |
| | D in mm | in Ppm | amount R | layer | recesses 4 | of cell | of cell |
| Example 1 | 1.5 | 7,500 | 10% | 30 | 1.2 | 80 | 32 |
| Example 32 | 1.5 | 15000 | 10% | 30 | 1.2 | 80 | 32 |
| Example 33 | 1.5 | 1500 | 30% | 30 | 1.2 | 80 | 32 |
| Example 34 | 1.5 | 5000 | 20% | 30 | 1.2 | 80 | 32 |
| Example 35 | 1.5 | 10000 | 5% | 30 | 1.2 | 80 | 32 |
| Example 36 | 1.5 | 1000 | 30% | 30 | 1.2 | 80 | 32 |

| | | | | External | | | |
|---|---|---|---|---|---|---|---|
| | Width | | Thickness | diameter | | Residual | |
| | V in μm | | M in μm | N in μm | | electrolyte | Lithium |
| | of first | Depth | of separator | of ceramic | | coefficient | plating |
| | recess 4 | H in μm | 3 of ceramic | particles | Q/(R*H) | in g/mAh | window |
| Example 1 | 80 | 15 | 2 | 0.1 | 5000 | 1.6 | 3.5 C-4.3 V |
| | | | | | | | to 2 C-4.5 V |
| Example 32 | 80 | 15 | 2 | 0.1 | 10000 | 1.6 | 3.5 C-4.3 V |
| | | | | | | | to 2 C-4.5 V |
| Example 33 | 80 | 3 | 2 | 0.1 | 1666.67 | 1.6 | 3.5 C-4.28 V |
| | | | | | | | to 2 C-4.5 V |
| Example 34 | 80 | 1 | 2 | 0.1 | 25000 | 1.6 | 3.5 C-4.27 V |
| | | | | | | | to 2 C-4.5 V |
| Example 35 | 80 | 1.5 | 2 | 0.1 | 133333.33 | 1.6 | 3.5 C-4.25 V |
| | | | | | | | to 2 C-4.5 V |
| Example 36 | 80 | 5 | 2 | 0.1 | 666.67 | 1.6 | 3.5 C-4.24 V |
| | | | | | | | to 2 C-4.5 V |

Referring to Table 7, it can be seen from Examples 1 and 32 to 36 that when the sum of the contents of aluminum and magnesium, the content of silicon and the depth satisfy 1*10³≤Q/(R*H)≤1*10⁵, i.e., when the lithium plating window in Examples 1 and 32 to 34 is greater than that in Examples 35 to 36, the greater the lithium plating window, the wider the charging window, and the higher the charging speed.

### Examples 37-41

Except for the ratio of the dimension of the extension 13 (the difference between the widths of the negative electrode plate 1 and the positive electrode plate 2) to the depth in Example 1, the rest are the same as those in Example 1. Please refer to Table 8 for the values of the dimension of the extension 13 and the depth and the ratios thereof in Examples 37-41.

TABLE 8

| | | Content | | Thickness | Spacing | | |
|---|---|---|---|---|---|---|---|
| | | of Al + | | P in μm | S in mm | | |
| | | content | Silicon | of second | between | Length | Width |
| | Extension 13 | of Mg Q | doping | active | first | L in mm | W in mm |
| | D in mm | in Ppm | amount R | layer | recesses 4 | of cell | of cell |
| Example 1 | 1.5 | 7,500 | 10% | 30 | 1.2 | 80 | 32 |
| Example 37 | 0.4 | 7,500 | 10% | 30 | 1.2 | 80 | 32 |
| Example 38 | 0.5 | 7,500 | 10% | 30 | 1.2 | 80 | 32 |
| Example 39 | 1.8 | 7,500 | 10% | 30 | 1.2 | 80 | 32 |
| Example 40 | 4 | 7,500 | 10% | 30 | 1.2 | 80 | 32 |
| Example 41 | 0.9 | 7,500 | 10% | 30 | 1.2 | 80 | 32 |

| | | | | External | | | |
|---|---|---|---|---|---|---|---|
| | Width | | Thickness | diameter | | Residual | |
| | V in μm | | M in μm | N in μm | | electrolyte | Lithium |
| | of first | Depth | of separator | of ceramic | | coefficient | plating |
| | recess 4 | H in μm | 3 of ceramic | particles | D/H | in g/mAh | window |
| Example 1 | 80 | 15 | 2 | 0.1 | 0.1 | 1.6 | 3.5 C-4.3 V |
| | | | | | | | to 2 C-4.5 V |
| Example 37 | 80 | 7.5 | 2 | 0.1 | 0.053 | 1.6 | 3.5 C-4.32 V |
| | | | | | | | to 2 C-4.5 V |
| Example 38 | 80 | 3 | 2 | 0.1 | 0.186 | 1.6 | 3.5 C-4.27 V |
| | | | | | | | to 2 C-4.5 V |
| Example 39 | 80 | 7.5 | 2 | 0.1 | 0.24 | 1.6 | 3.5 C-4.26 V |
| | | | | | | | to 2 C-4.5 V |
| Example 40 | 80 | 15 | 2 | 0.1 | 0.26 | 1.6 | 3.5 C-4.25 V |
| | | | | | | | to 2 C-4.5 V |
| Example 41 | 80 | 3 | 2 | 0.1 | 0.3 | 1.6 | 3.5 C-4.24 V |
| | | | | | | | to 2 C-4.5 V |

Referring to Table 8, it can be seen from Examples 1 and 37 to 41 that when the dimension of the extension 13 and the depth satisfy 0.05≤D/H≤0.25, i.e., when the lithium plating window in Examples 1 and 37 to 39 is greater than that in Examples 40 to 41, the greater the lithium plating window, the wider the charging window, and the higher the charging speed.

### Examples 42-43

Except for the minimum distance between an edge of the second recess 5 and the first recess 4 in Example 1, the rest are the same as those in Example 1. Please refer to Table 9 for the minimum distance between the edge of the second recess 5 and the first recess 4 in Examples 42-43.

TABLE 9

| | | Content | | Thickness | Spacing | | |
|---|---|---|---|---|---|---|---|
| | | of Al + | | P in μm | S in mm | | |
| | | content | Silicon | of second | between | Length | Width |
| | Extension 13 | of Mg Q | doping | active | first | L in mm | W in mm |
| | D in mm | in Ppm | amount R | layer | recesses 4 | of cell | of cell |
| Example 1 | 1.5 | 7,500 | 10% | 30 | 1.2 | 80 | 32 |
| Example 42 | 1.5 | 7,500 | 10% | 30 | 1.2 | 80 | 32 |
| Example 43 | 1.5 | 7,500 | 10% | 30 | 1.2 | 80 | 32 |

| | | | | | Minimum | | |
|---|---|---|---|---|---|---|---|
| | | | | | distance | | |
| | | | | External | T/U in mm | | |
| | Width | | Thickness | diameter | between | Residual | |
| | V in μm | | M in μm | N in μm | edge of | electrolyte | Lithium |
| | of first | Depth | of separator | of ceramic | second | coefficient | plating |
| | recess 4 | H in μm | 3 of ceramic | particles | recess 5 | in g/mAh | window |
| Example 1 | 80 | 15 | 2 | 0.1 | 1 | 1.6 | 3.5 C-4.3 V |
| | | | | | | | to 2 C-4.5 V |
| Example 42 | 80 | 15 | 2 | 0.1 | 0.5 | 1.6 | 3.5 C-4.3 V |
| | | | | | | | to 2 C-4.5 V |
| Example 43 | 80 | 15 | 2 | 0.1 | 0 | 1.57 | 3.5 C-4.3 V |
| | | | | | | | to 2 C-4.5 V |

Referring to Table 9, it can be seen from Example 1 and Examples 42-43 that when the minimum distance between the edge of the second recess 5 and the first recess 4 is greater than 0, i.e., when the residual electrolyte coefficient in Examples 1 and 42 are greater than that in Example 43, the greater the residual electrolyte coefficient of the cell, the longer the battery life.

The basic principles of the present application have been described above with reference to the specific embodiments, but it should be noted that the advantages, superiorities, effects and the like mentioned in the present application are merely examples rather than limitations, and these advantages, superiorities, effects and the like cannot be considered to be necessary for all the embodiments of the present application. In addition, the specific details disclosed above are only for the purposes of illustration and easy understanding but not limitation, and the above details do not restrict the present application from being implemented by using the above specific details.

The block diagrams of devices, apparatuses, equipment and systems involved in the present application are only illustrative examples and are not intended to require or imply that they must be connected, arranged and configured in the manners shown in the block diagrams. As will be appreciated by those skilled in the art, these devices, apparatuses, equipment and systems can be connected, arranged and configured in any way. Words such as “including”, “comprising”, “having”, etc. are open-ended words that mean “including but not limited to” and can be used interchangeably therewith. The words “or” and “and” as used herein refer to the words “and/or” and can be used interchangeably therewith unless the context clearly indicates otherwise. The word “such as” as used here refers to the phrase “such as, but not limited to” and can be used interchangeably therewith.

It should also be noted that in the apparatus, device and method of the present application, each component or each step can be decomposed and/or recombined. These decompositions and/or recombinations should be regarded as equivalent solutions of the present application.

The above description of the disclosed aspects is provided to enable any person skilled in the art to make or use the present application. Various modifications to these aspects will be readily apparent to those skilled in the art, and the general principles defined herein may be applied to other aspects without departing from the scope of the present application. Therefore, the present application is not intended to be limited to the aspects shown herein, but to be in the broadest scope consistent with the principles and novel features disclosed herein.

It should be understood that the qualifiers “first”, “second”, “third”, “fourth”, “fifth” and “sixth” used in the description of the embodiments of the present application are only used to explain the technical solutions more clearly and are not intended to limit the scope of protection of the present application.

The above description has been given for purposes of illustration and description. Moreover, this description is not intended to limit the embodiments of the present application to the form disclosed herein. While various example aspects and embodiments have been discussed above, those skilled in the art will recognize certain variations, modifications, alterations, additions and sub-combinations thereof.

What is claimed is:

1. A cell, comprising a positive electrode plate, a separator, and a negative electrode plate, the negative electrode plate comprising a negative electrode current collector and a negative electrode active material layer, wherein a surface of the negative electrode active material layer is provided with a first recess,
the first recess has a depth H in μm, the cell has a length L in mm, and the cell has a width W in mm; and H, L and W satisfy: 0.05H≤L/W≤0.5H.

2. The cell according to claim 1, wherein 1≤L/W≤5;
H is in a range of 2≤H≤40; and/or
L is in a range of 20≤L≤160; and/or
W is in a range of 15≤W≤80.

3. The cell according to claim 1, wherein a spacing S in mm is provided between the first recesses, wherein W and S satisfy: 0.01≤S/W≤0.06; and
preferably, S is in a range of 0.5≤S≤3.

4. The cell according to claim 1, wherein a spacing S in mm is provided between the first recesses, wherein H, L, W and S satisfy: 0.04 H≤L*S/W≤0.45 H; and
preferably, S is in a range of 0.5≤S≤3.

5. The cell according to claim 1, wherein the separator is located between the positive electrode plate and the negative electrode plate, the separator comprises a ceramic layer close to the positive electrode plate, and the ceramic layer has a thickness M in μm, wherein M and H satisfy: 2.5≤H/M≤40; and
preferably, M is in a range of 0.3≤M≤5.

6. The cell according to claim 1, wherein the separator is located between the positive electrode plate and the negative electrode plate, the separator comprises a ceramic layer close to the positive electrode plate, Dv50 of the ceramic layer is defined as N in μm, and the first recess has a width Vin μm, wherein N and V satisfy: 3≤V/N≤3,000;
preferably, V is in a range of 20≤V≤200; and/or N is in a range of 0.02≤N≤2.

7. The cell according to claim 1, wherein the negative electrode active material layer is arranged on at least one side of the negative electrode current collector, the negative electrode active material layer comprises a first active layer close to the negative electrode current collector and a second active layer away from the negative electrode current collector, and Dv50 of an active material of the first active layer is greater than Dv50 of an active material of the second active layer, and the second active layer has a thickness P in μm, wherein P and H satisfy: 1<P/H≤5; and
preferably, P is in a range of 8≤P≤1,000.

8. The cell according to claim 1, wherein the positive electrode plate comprises a positive electrode current collector and a positive electrode active material layer, a sum of contents of aluminum and magnesium of an active material of the positive electrode active material layer is defined as Q in ppm, and a content of silicon of an active material of the negative electrode active material layer is defined as R, wherein Q, R and H satisfy: 1*10³≤Q/(R*H)≤1*10⁵;
Q is in a range of 1,000≤Q≤10,000; and/or R is in a range of 1%≤R≤30%.

9. The cell according to claim 1, wherein the negative electrode plate is provided with an extension beyond the positive electrode plate in a length direction of the cell, the extension having a dimension D in mm in the length direction of the cell, wherein D and H satisfy: 0.05≤D/H≤0.25; and
preferably, D is in a range of 0.1≤D≤2.

10. The cell according to claim 1, wherein a second recess is formed in a region of the negative electrode active material layer opposite to a positive tab of the cell in a thickness direction of the cell, and distances between two lateral edges of the second recess and adjacent first recesses are defined as T in mm and U in mm respectively in a width direction of the cell, wherein T and U are both greater than 0.

11. A lithium-ion secondary battery, comprising a housing and a cell of claim 1 arranged inside the housing.
